(19) United States
(12) Patent Application Publication
(10) Pub. No.: US 2005/0086087 A1
(43) Pub. Date: Apr. 21, 2005

(54) Method and system for searching for travel itineraries with flexible travel dates

(76) Inventors: Anne Marie Razza, Villa Park, IL (US); Michael Alford, Chicago, IL (US); Gillian Jetson Tarinelli, Naperville, IL (US)

Correspondence Address: WILDMAN, HARROLD, ALLEN & DIXON, 225 WEST WACKER DRIVE, CHICAGO, IL, 60606, US

(21) Appl. No.: 10/687,366

(22) Filed: Oct. 15, 2003

(51) Int. Cl. G06F 17/60

(52) U.S. Cl. 705/5; 705/6

(57) ABSTRACT

The present invention relates to a system and methods for searching for and displaying travel itineraries and fares that satisfy a traveler's flexible travel requirements. Users may enter data relating to a trip's origin and destination as well as various dates the user can travel. The systems and methods locate multiple itineraries that cover the various dates on which the user can travel. The system and methods disclosed herein allow prospective travelers to efficiently identify which itineraries best meet their schedules and budgetary requirements.

### BACKGROUND OF THE INVENTION

The present invention relates to a system and methods of searching for travel itineraries where the user, a potential traveler, has a certain degree of flexibility as to the dates he or she is willing to or desires to travel on.

Most travel related web sites today require a user to enter the city or airport they are departing from, the city or airport they are traveling to, their date of departure and their date of return. Upon entering the search data, the user's computer sends a search request to the webserver hosting the web site. The webserver receives the request and back-end systems which are transparent to the user search for travel itineraries that meet the user's requirements. The results of the search are then sent by the web site's webserver to the user's computer where they are displayed for the user. It must be noted, however, that such results only include itineraries having the specified departure and return dates. In order to review itineraries having alternate travel dates the user must submit a new search specifying the alternate travel dates.

In many cases potential travelers, especially leisure travelers, may have some flexibility in their schedules. Such travelers may wish to explore many different travel dates in order to locate the itinerary that best meets their travel plans or which has the lowest fare. However, since travel sites require specific dates to be entered for each search, the user is forced to initiate multiple searches in order to explore all of his or her travel options. If the user has several possible travel dates this can be a tedious and time consuming process. It also leads to difficulties in comparing the fares from one search to another. After performing two or three different searches it becomes difficult to recall the details of the various search results. Thus, to compare fares, the user must constantly page back and forth between one set of search results and another in order to determine the best fare for the travel dates which work best with his or her travel schedule.

In light of the difficulties presented to users of on-line travel web sites in searching for fares for multiple alternative travel dates, an improved system and method for searching for fares is needed. Preferably such a system and methods would allow users to search for itineraries and fares for multiple travel dates simultaneously. Such search methods should allow users to specify a general time period in which they want to travel, specify generally preferred travel dates with some degree of flexibility around the departure and return dates, or specify a trip of a certain length to be taken anytime between specified dates. Preferably such an improved system and search methods would display search results for multiple travel date pairs in a succinct easy to comprehend manner so that a user may quickly determine which itinerary and which fare works best with his or her schedule and budget.

### SUMMARY OF THE INVENTION

The present invention relates to a system and methods for identifying and displaying fares for travel itineraries corresponding to multiple travel date pairs that meet a user's flexible travel requirements. According to an embodiment of the invention, a method of identifying a plurality of alternate travel itineraries begins with the step of receiving a set of flexible travel requirements from the user. All departure and return date pairs that satisfy the flexible travel requirements are determined, and a database search is performed to identify travel itineraries corresponding to each of the departure and return date pairs.

Another embodiment of the invention also provides a method of searching for travel itineraries. This method includes identifying one or more departure dates and one or more return dates. Either or both of the at least one departure date and the at least one return date include multiple dates. Date pairs are formed based on every combination of the at least one departure date and at least one return date. A search is then performed for travel itineraries and fares for each date pair and the results are displayed for the user.

Another aspect of the invention relates to a method of displaying fares for a plurality of travel itineraries where the itineraries encompass multiple alternative travel dates. This method includes creating a matrix of rows and columns. Date pairs are created at the intersections of the rows and columns of the matrix, with a departure date associated with either the row or columns and return date associated with the other of the rows and columns. Fares then are displayed at the intersections of the rows and columns. The fares correspond to itineraries that include departure and return dates corresponding to the date pair defined by row and column in which the fare is listed.

Finally, a system for searching for and displaying travel itineraries and fares for flexible travel schedule is provided. The system includes a web server for receiving a users flexible travel requirements over a network. The web server, an application server or a search engine determines all pairs of departure and return dates that satisfy the flexible travel requirements; and the search engine searches a database to identify itineraries corresponding to said date pairs. Search results are then transmitted to a user over the network and displayed for the user.

Additional features and advantages of the present invention are described in, and will be apparent from, the following Detailed Description of the Invention and the figures.

### BRIEF DESCRIPTION OF THE FIGURES

FIG. 1 is a block diagram of a system for searching for travel itineraries using flexible travel dates according to an embodiment of the invention.

FIG. 2 is an initial search page in which a user may enter travel requirements.

FIG. 3 is a flexible search page in which a user may select a flexible search options and enter flexible travel requirements, where the user has selected a first flexible search option—weekends.

FIG. 4 is a results page for displaying search results from a flexible search according to option 1—weekends.

FIG. 5 is a results page for displaying search results for an itinerary and fare search for fixed travel dates based on a result displayed in the results page of FIG. 4.

FIG. 6 is the flexible search page of FIG. 3, but where the user has selected flexible search option 2—bonus days.

FIG. 7 is a results page for displaying search results from a flexible search according to flexible search option 2—bonus days.

FIG. 8 is a results page for displaying search results for an itinerary and fare search for fixed travel dates based on a result displayed in the results page of FIG. 7.

FIG. 9 is the flexible search page of FIGS. 3 and 6, but where the user has selected flexible search option 3—flexible stays.

FIG. 10 is a results page for displaying search results from a flexible search according to flexible search option 3—flexible stays.

FIG. 11 is a results page for displaying search results for an itinerary and fare search for fixed travel dates based on a result displayed in the results page of FIG. 10.

### DETAILED DESCRIPTION OF THE INVENTION

The present invention relates to a system and methods for searching for and displaying fares for travel itineraries corresponding to multiple travel date pairs that satisfy a traveler's flexible travel requirements. The system and methods disclosed herein allow prospective travelers to efficiently identify which itineraries best meet their schedules and budgetary requirements.

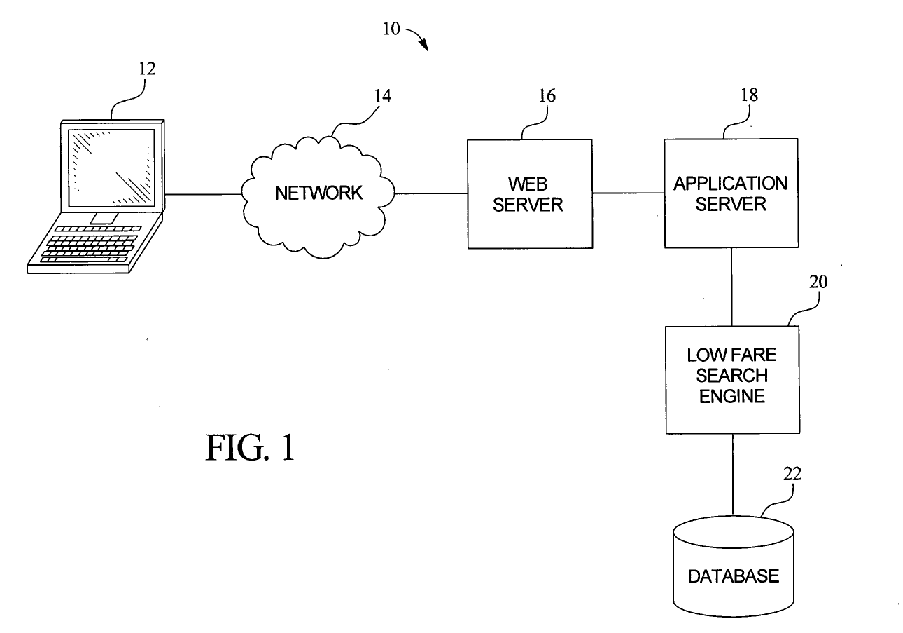

FIG. 1 shows a block diagram of a system 10 for searching for and displaying travel itineraries according to the present invention. The system 10 includes a user computer 12 and a webserver 16. The user computer 12 receives input commands and data from an end user of the system 10, and interacts with the webserver 16 via a computer network 14 such as the internet. The webserver 16 is adapted to send web pages to and receive requests and data from the user computer 12. The web pages sent to the user computer 12 by the webserver 16 are displayed on the user terminal's display monitor and form a user interface by which the user interacts with the system 10. Back-end processing equipment, including application server 18, low fare search engine 20, and data database 22 process user requests and generate the data which populate webpages sent from the webserver 16 to user computer 12.

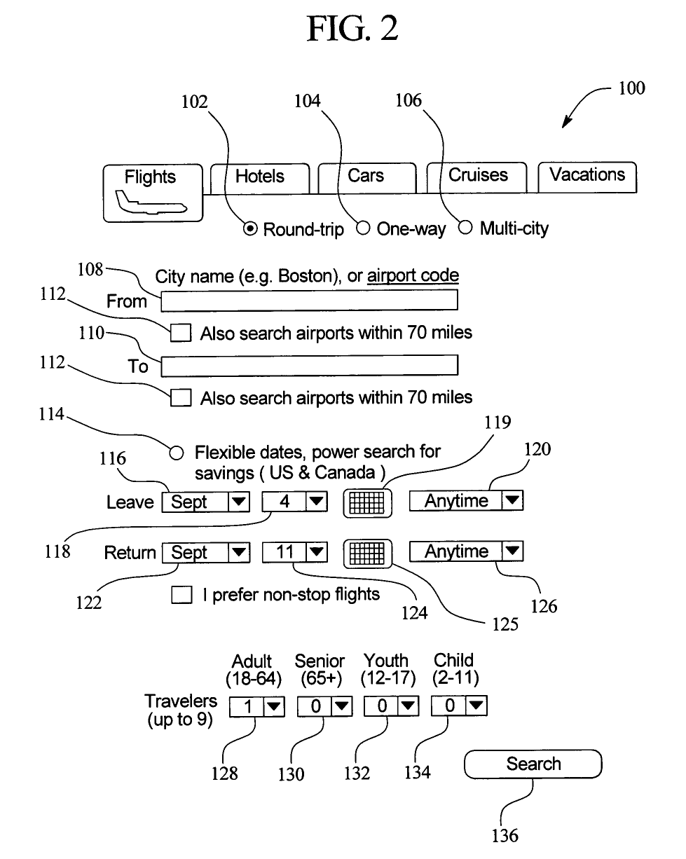

Various web pages that form the user interface for the system 10 are shown in FIGS. 2-11. The various interface pages include data fields, drop down menus, radio buttons, software buttons, hypertext links, and other interactive features which allow the user to enter data, request searches and book itineraries on system 10. The webserver 16 receives data entered by the customer and forwards the data to the application server 18. The application server 18 formulates queries based on the data entered by the customer and sends the queries to the low fare search engine 20, which searches the database 22 for itineraries and their associated fares that meet the customer's requirements. When a search is complete, the low fare search engine 20 forwards the search results to the application server 18 which generates a results page that webserver 16 sends to the user computer 12 via network 14 where the results are displayed for the customer.

FIG. 2 shows an initial search page 100 which is sent from the webserver 16 to the user computer 12 where it is displayed for the customer. The initial search page 100 includes a number of input options that allow the user to enter data relating to his or her travel requirements. For example, from the initial search page 100 a user may select a round trip, a one-way trip, or a trip encompassing multiple stops at different cities by selecting any one of the Round Trip radio button 102, the One-way radio button 104 or the Multi-city radio button 106. Next, the user enters the name of the city or the airport code of the airport they will be departing from in the FROM data field 108 and the city or airport they will be traveling to in the TO data field 110. A user can select searches that also explore itineraries including flights in and out of alternative airports by selecting the checkbox 112 for searching airports within 70 miles of the airports entered in the FROM and TO fields 108, 110.

If a user must travel on specific dates the user can ignore the flexible dates radio button 114 and enter his or her travel dates in the leave/return fields 116, 118, 120, 122, 124 and 126. Drop down menus are provided to assist the user in entering travel dates and times. The drop down menus are accessed by selecting the downward pointing arrow adjacent to each field. Alternatively, the user may select the calendar icons 119, 125 to select travel dates. Selecting the calendar icons causes calendar pages to be displayed wherein a user may select a departure or return date (depending on which calendar icon is selected) by clicking a particular date displayed on the calendar preferably two months are displayed at one time, and arrow buttons allow the user to page forward and back between different months. Similarly, users may enter data on the number of passengers in various demographic categories who will be traveling by entering the appropriate number in the Adult, Senior, Youth and Child fields, 128, 130, 132 and 134. Once the user has entered all of the appropriate data, the user initiates a search by selecting the Search button 136.

A traditional search, a search with fixed travel dates, looks for itineraries between the designated cities or airports that meet the date and time and geographic requirements entered by the user. The results are then presented to the user.

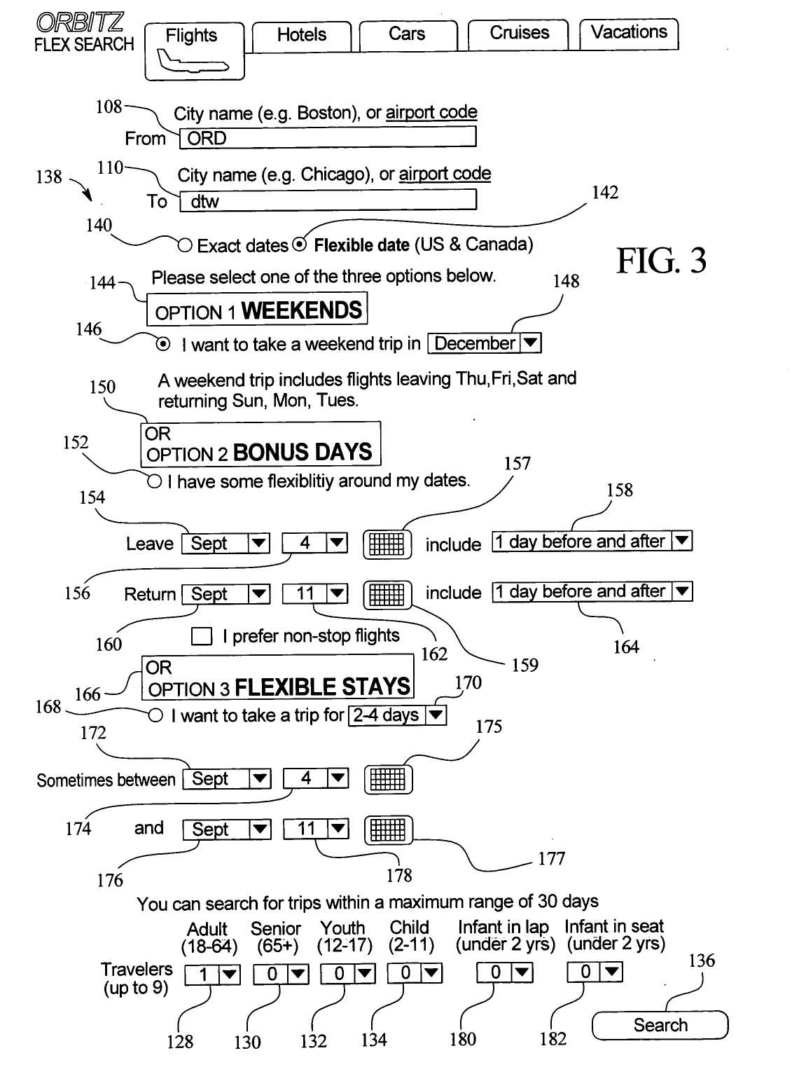

If a user has some flexibility regarding his or her travel dates, however, the user may select the Flexible Dates radio button 114. Selecting the Flexible Dates radio button 114 causes the interface page 138 shown in FIG. 3 to be displayed. According to an embodiment of the invention, interface page 138 allows the user to enter various flexible travel requirements where alternative dates are available for at least one of the departure date and the return date. Interface page 138 includes three flexible search options: Option 1 Weekends 144; Option 2 Bonus Days 150; and Option 3 Flexible Stays 166. Any one of the three flexible search options may be selected by mouse clicking, or otherwise setting the radio buttons 146, 152 or 168 associated with each of the flexible search options.

As with a traditional search, a flexible search using the methods of the present invention begins when the user enters the cities or airports he or she will be departing from and traveling to. The user enters either the city or airport code of the city the user is departing from in the “From” field 108 and enters the city or airport code of the destination city in the “To” field 110. In cases where the user enters the city or airport he or she will be departing from and flying to in the FROM and TO data fields 108, 110 on the initial search page 100 prior to selecting the flexible search radio button 114, the airports or cities entered will be carried over to the flexible search page 138 so that the user need not re-enter this data. The Flexible Dates radio button 142 is selected by default, since the user accessed the flexible search page 138 by selecting the “flexible dates—power search for savings” radio button 114 on the interface page 100 displayed in FIG. 2. Selecting the “Exact Dates” radio button 140 from the flexible search page 138 of FIG. 2 returns the user to the standard search page 100 of FIG. 1.

The first flexible search option, Option 1 Weekends 144, allows a user to search for all available itineraries and fares for a weekend trip on any weekend within a specified date interval. According to the embodiment displayed in FIG. 3, a specified date interval corresponds to a calendar month. Option 2 Bonus Days 150, allows the user to search for itineraries and fares that center around specific dates, but where the user may specify additional days before and/or after the specified departure and return dates that are also acceptable. Option 3 Flexible Stays 166 allows a user to search for itineraries and fares for trips of a specified trip length to be taken within a specified date range.

A user accesses Option 1 Weekends 144 by selecting the “I want to take a weekend trip in . . . ” radio button 146. The user specifies the particular month that he or she wants to travel in by selecting the desired month to be entered in the Month data field 148. Alternately, the radio button 146 will be selected automatically when the user selects a desired month in the month field 148 directly. Passenger type data is entered in the passenger type data fields 128, 130, 132, 134, 180, 182. These are the same as those on the traditional search page 100 (FIG. 2) with the addition of the Infant In-Lap 180, and Infant-In-Seat data fields 182. These additional fields are present for each of the flexible search options. A list of available months may be displayed by selecting the downwardly pointing arrow adjacent to the data field 148. Once the desired month is entered, the user initiates a search by selecting the Search button 136 at the bottom of the page.

As explained under the Option 1 Weekends heading 144, a weekend trip is defined in this embodiment as any trip leaving on a Thursday, Friday or Saturday of a given week, and returning on a Sunday, Monday or Tuesday of the following week. Of course, weekends may be defined in alternate ways, such as Friday through Sunday or some other way. In any case, when a weekend search is initiated, the system identifies every possible date pair for weekend trips in the given month and searches for itineraries having the best (lowest) fare for each date pair.

In the example shown in FIG. 3 the user has selected an Option 1 Weekends search. The user will be traveling from Chicago O'Hare airport to Detroit Metro airport. The user has selected December 2003 as the month in which he or she wishes to travel. There are four weekends in December 2003. According to the definition of “weekend” employed in this embodiment, the four weekends in December 2003 extend from Thursday, December 4 to Tuesday, December 9; Thursday, December 11 to Tuesday, December 16; Thursday, December 18 to Tuesday, December 23; and Thursday, December 25 to Tuesday, December 30. In this example there are no weekends that overlap with the previous month or extend into following month. However, when such overlapping weekends do exist, the system can be configured to either include or exclude them when performing an Option 1 Weekends search. Generally, it is considered better to include overlapping weekends in an Option 1 Weekends search, otherwise the window of available weekends may be too small. Furthermore, if the user selects a weekend trip in the present month, dates that have already passed will be excluded from the search. Based on Thursday, Friday or Saturday departures and Sunday, Monday or Tuesday returns, there are 9 date pairs per weekend and 36 date pairs total that must be searched for weekend trips in December 2003. For example, the date pairs for the first weekend in December are as follows.

| | | | |
|---|---|---|---|
| Depart | Thursday | December | 4 |
| Return | Sunday | December | 8 |
| Depart | Thursday | December | 4 |
| Return | Monday | December | 9 |
| Depart | Thursday | December | 4 |
| Return | Tuesday | December | 10 |
| Depart | Friday | December | 5 |
| Return | Sunday | December | 8 |
| Depart | Friday | December | 5 |
| Return | Monday | December | 9 |
| Depart | Friday | December | 5 |
| Return | Tuesday | December | 10 |
| Depart | Saturday | December | 6 |
| Return | Sunday | December | 8 |
| Depart | Saturday | December | 6 |
| Return | Monday | December | 9 |
| Depart | Saturday | December | 6 |
| Return | Tuesday | December | 10 |

Similar date pairings must be searched for the second, third and fourth weekends of December as well. Some months may have as many as 5 weekends that must be searched in the course of a weekend search according to this embodiment of the invention.

The user initiates the Option 1 Weekends search by selecting the Search button 136. This causes a search message to be sent from the user computer 12 via the network 14 to the webserver 16 (FIG. 1). The search message includes all of the relevant data regarding the user's search requirements. The data received by the webserver 16 are forwarded to the application server 18 which formulates a search query that is submitted to the Low Fare Search Engine 20. The query includes all of the information necessary for the Low Fare Search Engine to calculate the date pairs that must be searched. The Low Fare Search Engine then accesses the database 22 to search for itineraries that meet the requirements of the search query. An algorithm within the Low Fare Search Engine identifies the itinerary having the best fare for each date pair being searched. The results are forwarded to the application server 18. The application server parses the search results and generates a results page which is sent by the webserver 16 to the user computer 12 via the network 14. The results page is then displayed by the user computer 12 for the customer to review.

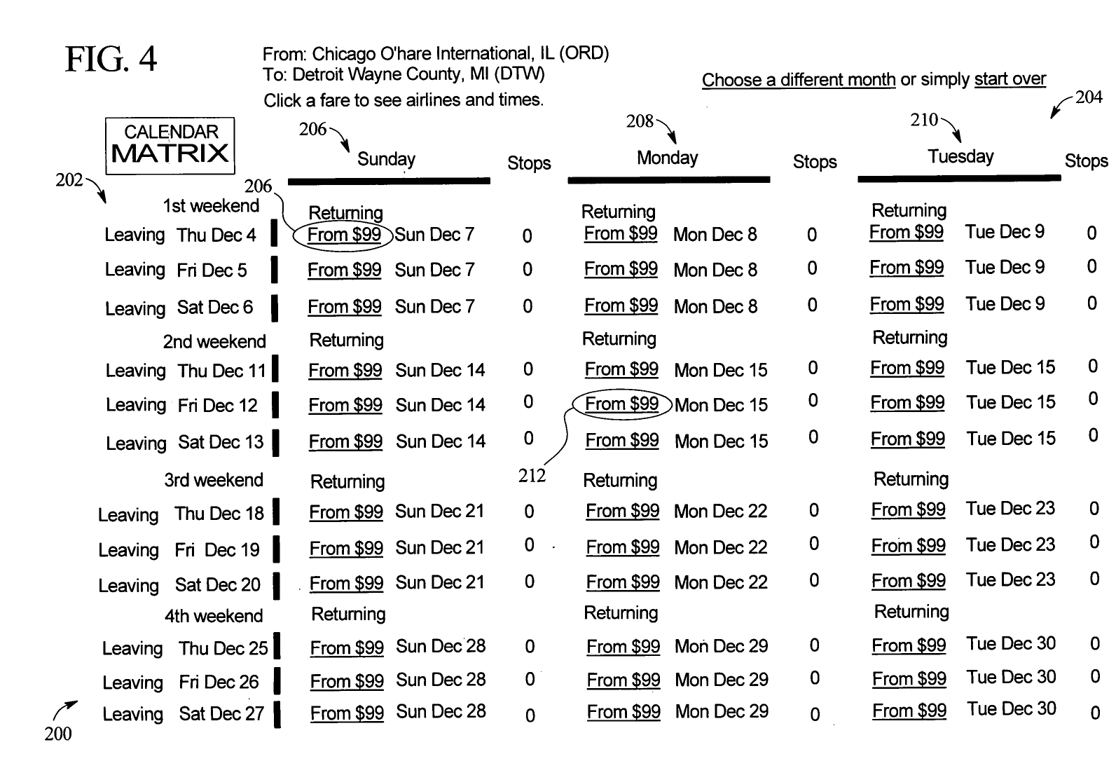

A results page 200 for the Option 1 Weekends search is shown in FIG. 4. It will be recalled that the user was searching for round trip itineraries between Chicago O'Hare Airport and Detroit Metro airport during any weekend in the month of December, 2003. The search results are displayed in a matrix format with departure dates (i.e., Thursday, Friday or Saturday) listed along the vertical axis 202 and possible return days (i.e. Sunday, Monday or Tuesday) listed along the horizontal axis 204. Along the vertical axis each potential departure date is grouped according to the particular weekend within which the potential departure date falls. Thus, Thursday, December 4, Friday, December 5 and Saturday, December 6 are grouped together under “1^{st} Weekend”; Thursday, December 11, Friday, December 12, and Saturday, December 13 are grouped together under “2^{nd} Weekend”; and so forth. Within each vertical column—Sunday 206; Monday 208, and Tuesday 210—each potential return date within the specified month (or within an adjacent month in the case of overlapping weekends) falling on the day specified at the head of the column is paired against a corresponding departure date within the corresponding weekend. Thus, a return date of Sunday, December 7 is paired against each of the departure dates Thursday, December 4, Friday, December 5, and Saturday, December 6 in the first column 206. The return date Monday, December 8 is also paired against each of the three departure dates of the first weekend, in the second column 208, as is the return date Tuesday, December 9 in the column 210. Similarly, each of the return dates Sunday, December 14, Monday, December 15, and Tuesday, December 16 are paired against each of the departure dates Thursday, December 11, Friday, December 12, and Saturday, December 13 of the second weekend in columns 206, 208 and 210, respectively. The date pairs of the third and fourth weekends are displayed in the same manner.

A price is displayed at the intersection of each column and row entry of the display matrix 200. Each price represents the lowest fare identified by the low fare search engine 20 for an itinerary having the departure and return dates corresponding to the row and column headings of the row and column in which the price appears. For example, the price “From $99” identified by reference number 212 corresponds to the lowest fare found by the low fare search engine for a round trip between Chicago O'Hare Airport and Detroit Metro Airport leaving on Friday, December 12 and returning Monday, December 15. When the user passes the mouse cursor over a fare, the travel dates with which the fare is associated are highlighted along with the matrix cell containing the fare itself. Thus, a user may easily identify the travel dates corresponding to a particular fare. From the matrix display 200 a user can easily identify the best fares and determine which weekend itinerary within the month of interest best suits his or her schedule.

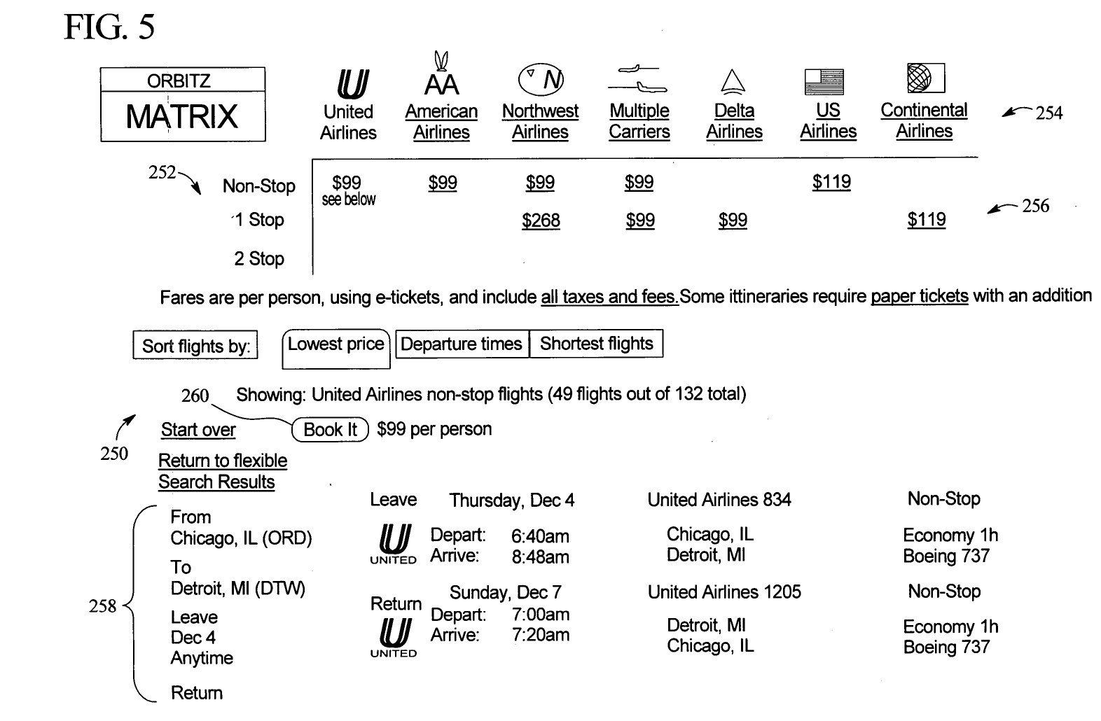

An additional feature of the display matrix 200 is that the price entries displayed in the matrix are actually hypertext links back to the webserver 16. When a user at user computer 12 mouse clicks or otherwise selects one of the fares displayed in the display matrix 200, a message is sent over the network 14 from the user computer 12 to the webserver 16. This message indicates that the user is interested in the specific travel dates represented by the fare's position in the matrix. This information is passed on to the application server 18 which formulates a second query to be submitted to the low fare search engine 20. This second query is a request to search for all itineraries between Chicago O'Hare and Detroit Metro on the specific travel dates selected by the user. Again, the application server 18 submits the query to the low fare search engine 20 and the low fare search engine searches the database 22 for itineraries corresponding to the specified dates. Upon completing the search the low fare search engine 20 returns the results set to the application server 18. The application server 18 then constructs a date specific results page that is sent by the webserver 16 to the user computer 12 via network 14, where it is displayed for the user. A typical results pages for a date specific search is shown in FIG. 5. In this case the search results reflect all of the itineraries available for a weekend trip from Chicago to Detroit leaving Thursday, December 4 and returning Sunday, December 7, in response to the user selecting the fare identified by reference number 214 in FIG. 4.

The date specific display page 250 also includes a display matrix 252. In this case the number of intermediate stops in a given itinerary is listed along the vertical axis and the air carriers offering the itineraries are listed across the horizontal axis. Fares are displayed at the intersections of the rows and columns. The flight details of itineraries corresponding to the fares listed in the matrix are displayed below the matrix. The fares are linked to the detailed entries displayed such that when a fare is selected in the matrix, all itineraries that meet the requirements corresponding to the fare's position within the matrix are displayed in a scrollable list below the matrix. Thus, selecting the $99 fare 253 in the first position of the matrix, for example, will cause all non-stop itineraries on United Airlines to be displayed below the matrix, the first of which 258 is included in FIG. 5. Selecting the “Book It” button 260 initiates the process in which the user books the itinerary.

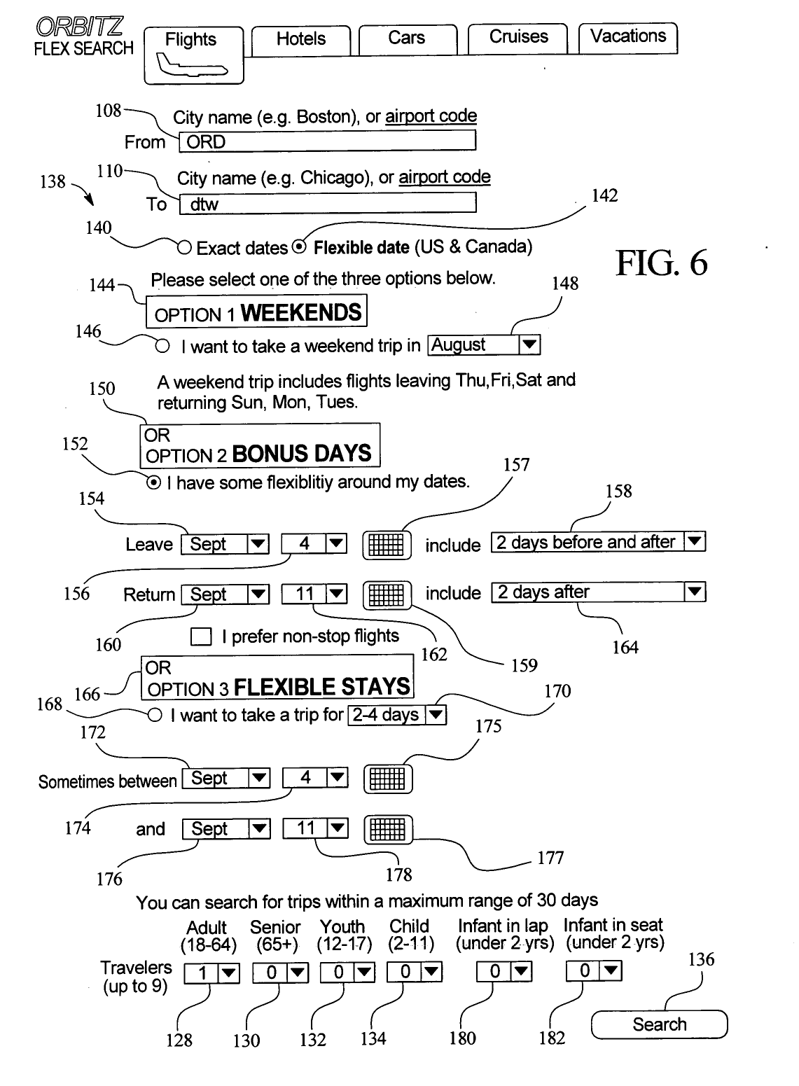

Turning to FIG. 6, the “Option 2 Bonus Days” flexible search will now be described. FIG. 6 shows the same flexible search options page 138 as that shown in FIG. 3, except that the radio button 152 for selecting the Option 2 Bonus Days flexible search option 150 has been selected. This indicates that the user wants to travel on a particular date, but has some degree of flexibility around his or her departure and/or return dates. There are several data fields and drop down menus associated with the Option 2 Bonus Days flexible search option 150. These include the Leave Month field 154, the Leave Date field 156, the Return Month field 160, and the Return Date field 162, and calendar icons 157, 159. There are also two fields 158, 164 in which the user can define the amount of flexibility he or she has around the dates entered in the leave date and return date fields. Menu lists of possible entries in the various data field may be displayed by selecting the downward pointing arrows adjacent to each field. Selecting the calendar icons allows the user to select dates directly off of a calendar that pops up when the icons are selected. In FIG. 6 the user has selected September in the Leave Month field 154, the number 4 in the Leave Date field 156, and “2 Days Before and After” in the Degree of Flexibility field 158. Similarly, the user has selected September in the Return Month field 160, the number 11 in the return date field 162, and “2 days after” in the degree of flexibility field 164. Upon entering the data into the flexible search page 138, the user initiates a search by selecting the Search button 136.

As with Search Option 1 Weekends, selecting the Search button 136 when Option 2 Bonus Days has been selected causes a message to be sent from the user computer 12 via the network 14 to the webserver 16. The message sent to the webserver 16 includes all of the relevant data entered by the user into the data fields 108, 110, 154, 156, 158, 160, 162, and 164. The webserver 16 forwards the search data to the application server 18 which then formulates a query to be submitted to the low fare search engine 20. In this case the query includes a range of dates for the departing flight and a range of dates for the return flight. Upon receiving the query, the low fare search engine 20 determines all of the possible date pairs created by the leave and return date ranges and searches the database 22 for itineraries having the lowest fares between the originating airport and the destination airport for each identified date pair. The low fare search engine 20 returns the search results to the application server 18. The application server 18 parses the search results and creates a results page which the webserver 16 sends to the user computer 12 over the network 14.

In the example shown in FIG. 6, the user has entered September 4 as the desired departure date, and included two days before and two days after that date as alternate departure dates in the degree of flexibility field 158. For the return trip the user has entered September 11 as the desired return date, and entered 2 days following in the degree of flexibility field 164. Thus, when the application server 18 receives this data, it formulates a query having a date range from September 2 to September 6 for departing flights and from September 11 to September 13 for return flights. From these date ranges the low fare search engine 20 calculates all date pairs that meet these flexible requirements. In this case there is a total of 15 date pairs that satisfy the user's flexible travel schedule. The low fare search engine searches the database 22 for the best fares on itineraries for each of the 15 identified date pairs.

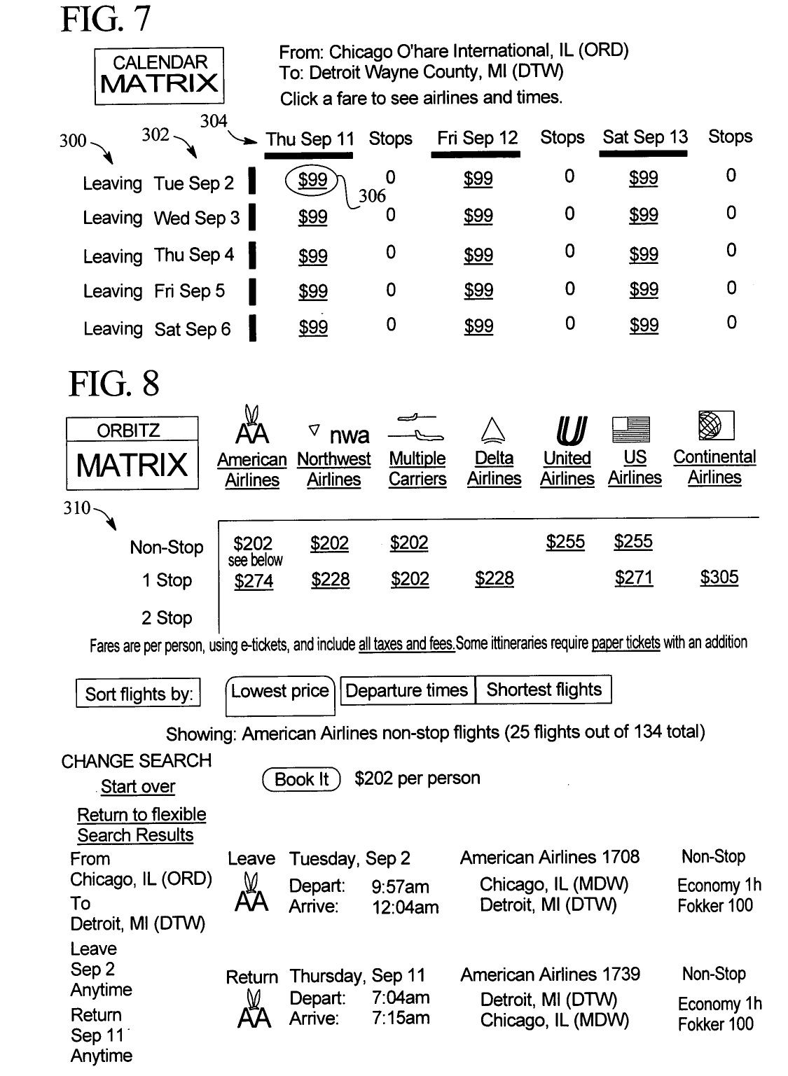

A sample results page 300 for the present example of an Option 2 Bonus Days flexible search is shown in FIG. 7. Again, the results are displayed in a matrix format. Departure dates Tuesday, September 2 through Saturday, September 6 are listed in rows along the vertical axis 302. Return dates Thursday, September 11 through Saturday, September 13 are listed in columns along the horizontal axis 304. Fares for each date pair are displayed at the intersection of each corresponding rows and columns. For example, the $202 fare designated by reference number 306 represents the best fare identified by the low fare search engine 20 for an itinerary that includes a departing flight from Chicago O'Hare Airport to Detroit Metro Airport on September 2, and a return flight on September 11.

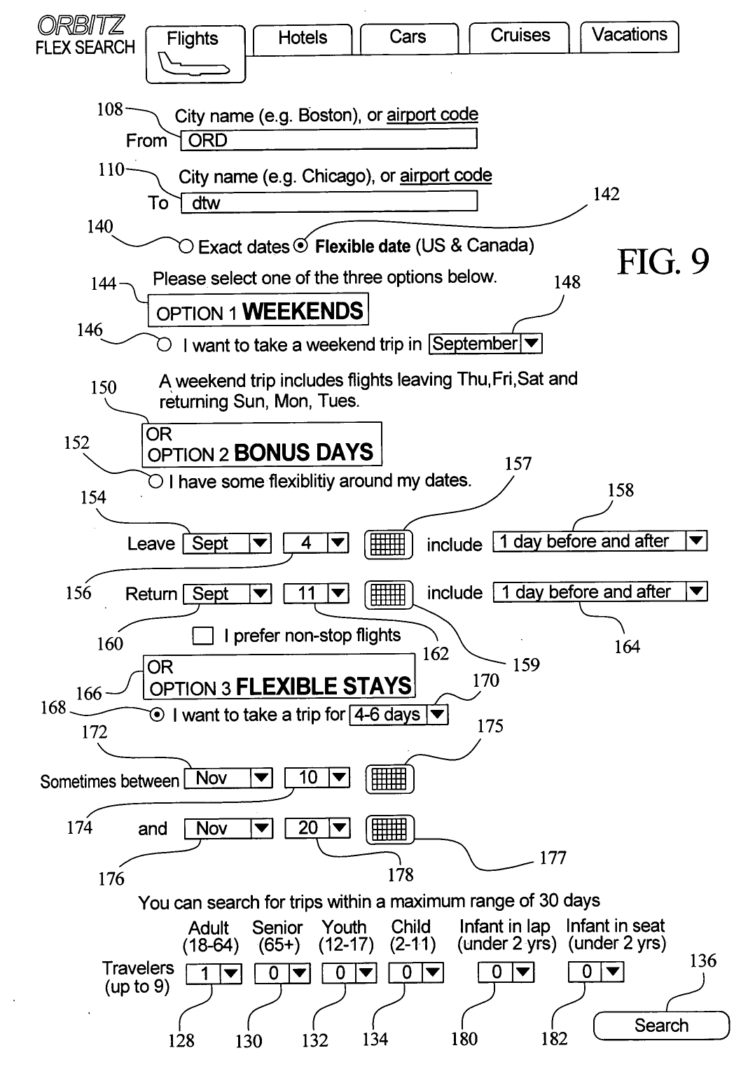

As with Option 1, the fares listed in the display matrix 300 are actually hypertext links. When the user clicks on one of the fares, a message is sent from the user computer 12 via the network 14 to the webserver 16. The message indicates that the user is interested in itineraries that include the specific date pair corresponding to the selected fare's position in the matrix. Again, this causes a new search to be performed. This second search locates all itineraries and their associated fares for the date pair corresponding to the position of the selected fare. The application server 18 assembles the search results into a display page which is sent to the user computer 12. The results of such a second search are shown in the display page 310 of FIG. 8. The composition of the display page 310 is substantially identical to that of display page 250 shown in FIG. 5, only the details regarding dates, flight numbers and such are different due to the different search criteria.

Finally, we turn to “Option 3 Flexible Stays” 166. FIG. 9 shows the same flexible search page 138 as that shown in FIGS. 3 and 6 except that in FIG. 9, the Option 3 Flexible Stays radio button 168 has been selected. The radio button 168 is adjacent to the statement “I want to take a trip for . . . ”, which in turn is followed by data field 170. A user may select a numerical range from the drop down menu displayed when the user selects the downward pointing arrow adjacent to the date field 170. The selected range indicates the number of days the user would like to spend on his or her trip. Additional data fields 172, 174, 176 and 178 are provided for entering the date range between which the user desires to take his or her trip. Alternatively the user can select a date rate range for his or her trip from calendars which pop up when the user selects the calendar icons 175, 177.

In the example shown in FIG. 9, the user has entered a range of 4-6 days in the data field 170. The user has also entered November 10 and November 20 in the data fields 172, 174, 176 and 178, as the dates between which the user wishes to travel. As with flexible search Options 1 and 2, after entering the data in the Option 3 Flexible Stays data fields, the user initiates the Option 3 Flexible Stays search by selecting the Search button 136. This causes a message to be sent from the user computer 12 via the network 14 to the webserver 16. The message indicates which type of flexible search the user has selected as well as the data the user has entered in data input fields 170, 172, 174, 176 and 178 and the traveler information 128, 130, 132, 134, 180, 182. The webserver 16 receives the message and forwards the flexible search data to the application 18 which formulates a search query that is submitted to the Low Fare Search Engine 20. The query generated by the application server 18 includes a range of acceptable departure dates and a range of acceptable return dates as well as the trip length requirement.

In the example shown in FIG. 9, the range of acceptable travel dates is between November 10 and November 20. Since the trip is to be 4 to 6 days long, the last departure date allows for a 4 day trip is November 17. Thus, the range of acceptable departure dates included in the query is from November 10 to November 17. Similarly the earliest return date for a 4 trip is November 13. Thus, the range of acceptable return dates included in the query is from November 13 to November 20. The Low Fare Search Engine calculates all possible date pairs for a trip of 4 to 6 days within the defined range. The low fare search engine 20 then accesses and searches the database 22 to identify the lowest fare for an itinerary for each date pair. The results of the search are returned to the application server 18 which generates a results page which is sent by the webserver 16 to the user computer 12 for display to the user via the network 14.

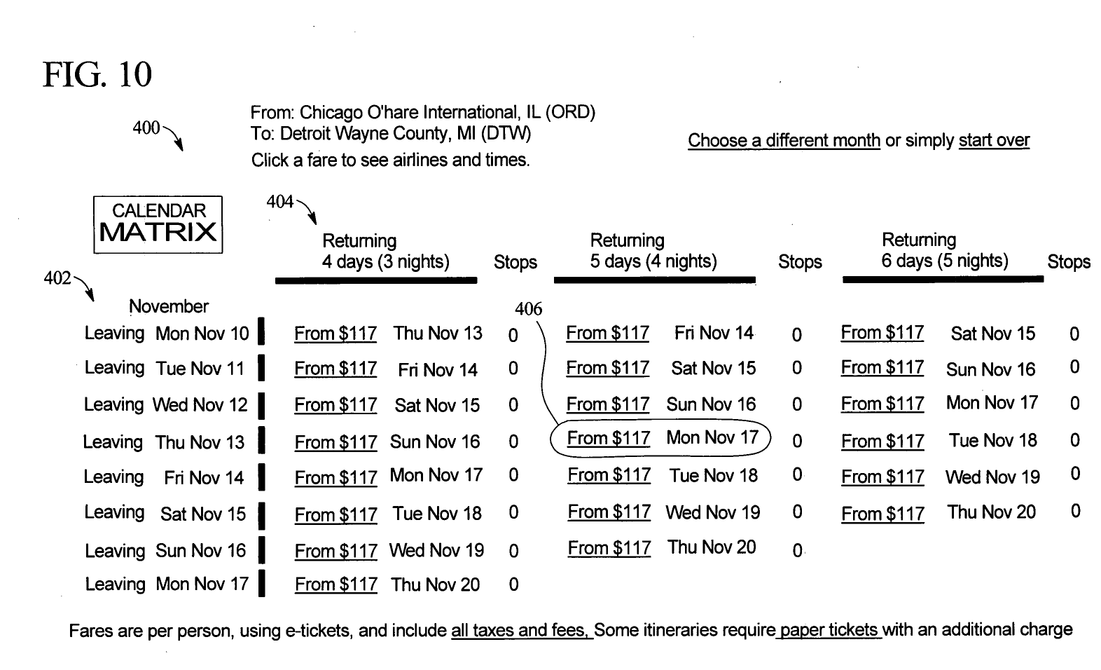

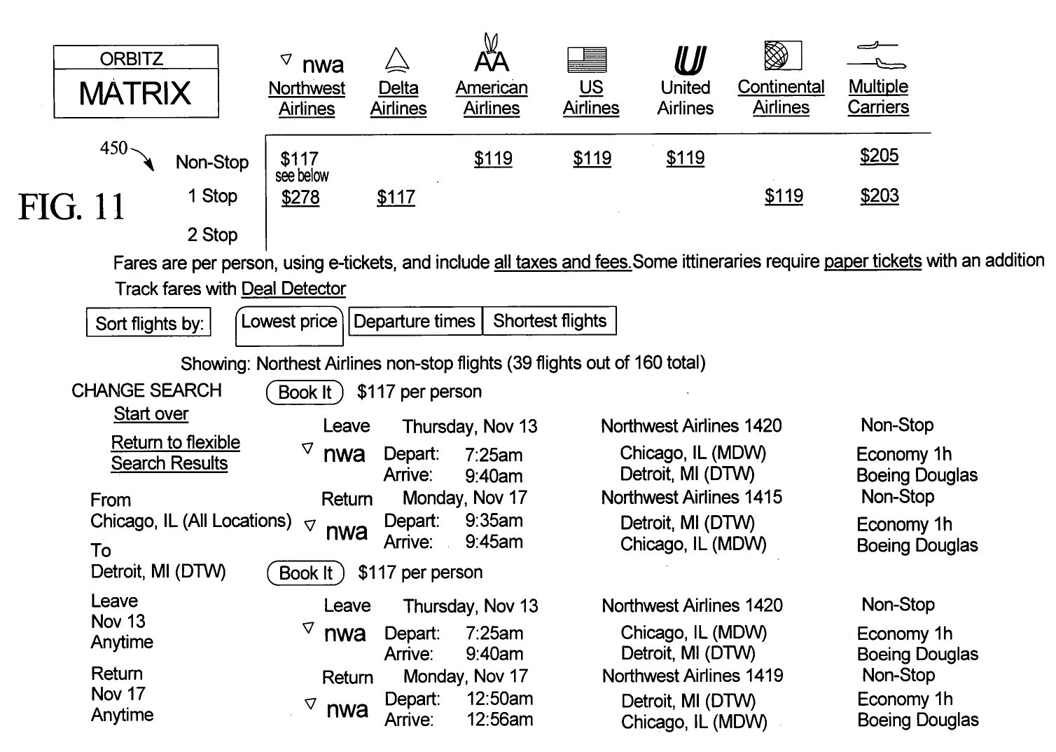

A sample results page 400 for an Option 3 Flexible Stays search is shown in FIG. 10. As with the results pages generated by flexible search options 1 and 2, the results page 400 displays the Flexible Stay Search results in a matrix format. The range of possible departure dates meeting the user's requirements are listed in separate rows along the vertical axis 402. Columns are created according to the length of the trip. In the present case, since the user specified a trip of from 4 to 6 days, there are three columns in the display matrix corresponding to a four day trip, a five day trip and a six day trip. Return dates are listed in each column. The return dates are arranged such that they line up with the proper departure date to create a trip of a length corresponding to the column heading in which the return date is located. For example, the top entry in the first column, 4 days (3 nights), is Thursday, November 13 which is lined up opposite the departure date of November 10. The interval between the departure date November 10 and the return date November 13 corresponds to a four-day (three-night) trip. All possible combinations for 4 day, 5 day and 6 day trips between November 10 and November 20 are displayed in the matrix display 400 in a like manner. The lowest fare for an itinerary corresponding to each date pair is displayed at the intersection of each row and column adjacent to the associated return date.

As with Options 1 and 2, the fares listed in the display matrix 400 are actually hypertext links. When the user clicks on one of the fares, a message is sent from the user computer 12 to the webserver 16 via the network 14. This message indicates that the user is interested in itineraries that include the specific date pair corresponding to the selected fare's position in the matrix. Again, this causes a new search to be performed. This second search locates all itineraries and their associated fares for the specific date pair selected. The application server 18 assembles the search results into a display page which is sent to the user computer 12. The results of such a second search are shown in the display page 450 of FIG. 11. The composition of the display page 450 is substantially identical to that of display page 250 shown in FIG. 5 and display page 310 of, FIG. 8, only the details regarding dates, flight numbers and such are different due to the different search criteria.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A method of identifying a plurality of alternate travel itineraries, the method comprising the steps of:
receiving a set of flexible travel requirements;
determining all pairs of departure and return dates that satisfy the flexible travel requirements;
identifying and displaying fares for itineraries corresponding to each of the departure and return date pairs.

2. The method of claim 1 wherein the itineraries are air travel itineraries.

3. The method of claim 1 wherein the set of flexible travel requirements comprises a date interval during which a weekend trip is desired.

4. The method of claim 3 wherein a weekend trip is defined as a Thursday, Friday or Saturday departure and a Sunday, Monday or Tuesday return.

5. The method of claim 4 wherein the step of determining all pairs of departure and return dates comprises identifying all weekends that occur during the date interval, and pairing each possible departure date associated with each possible return date for the corresponding weekend for each weekend that occurs within the date interval.

6. The method of claim 5 wherein the date interval comprises a calendar month.

7. The method of claim 1 wherein the step of receiving a set of flexible travel requirements comprises receiving a desired departure date and a desired return date and receiving at least one of a specified number of days preceding said desired departure date, a specified number of days following said departure date; a specified number of days preceding said desired return date, and a specified number of days following said desired return date.

8. The method of claim 7 wherein the step of determining all pairs of departure and return dates satisfying said flexible travel requirements comprises identifying all possible departure dates based on the desired departure date and the specified number of acceptable days preceding the desired departure date and the number of acceptable travel days following said desired departure date; identifying all possible return dates based on the desired return date and the specified number of acceptable travel days preceding the desired return date and the number of acceptable travel days following the desired return date; and pairing each possible departure date with each possible return date.

9. The method of claim 1 wherein the step of receiving a set of flexible travel requirements comprises receiving a date interval and a trip length.

10. The method of claim 9 wherein said date interval is a first date and a second date.

11. The method of claim 9 wherein said trip length is expressed as a numerical value or a numerical range setting forth the desired length of the trip in days.

12. The method of claim 9, wherein the step of identifying all pairs of departure and return dates that satisfy the flexible travel requirements comprises determining all possible departure dates and all return dates within the date interval that encompasses a trip of the received trip length.

13. A method of searching for travel itineraries comprising the steps of:
identifying one or more departure dates and one or more return dates, where at least one of said one or more departure date and said one or more return dates comprises a plurality of dates;
identifying a plurality of date pairs each date pair comprising one of said one or more departure dates and one of said one or more return dates;
searching for fares for itineraries corresponding to each date pair; and
displaying said fares.

14. The method of claim 13 wherein the step of identifying one or more departure dates and one or more return dates further comprises identifying every weekend within a defined date range, and identifying at least one departure date and at least one return date for each weekend.

15. The method of claim 13 wherein identifying at least one departure date for each weekend comprises identifying a date corresponding to at least one of Thursday, Friday and Saturday of each weekend within said defined date range and identifying at least one return date comprises identifying a date corresponding to at least one of Sunday, Monday and Tuesday of each weekend within said defined date range.

16. The method of claim 13 wherein said defined date range is a calendar month.

17. The method of claim 13 wherein the step of identifying one or more departure dates and one or more return dates includes receiving a specified departure date and a range of days preceding and/or following said specified departure date.

18. The method of claim 13 wherein the step of identifying one or more departure dates and one or more return dates includes receiving a specified return date and a range of days preceding and/or following said specified return date.

19. The method of claim 13 wherein the step of identifying one or more departure dates and one or more return dates includes receiving a range of dates and receiving a specified trip length, wherein the at least one departure date is identified as every date within said date range which can accommodate a trip of the specified trip length within said date range.

20. The method of claim 13 wherein the step of identifying one or more departure dates and one or more departure dates and one or more return dates includes receiving a range of dates and receiving a specified trip length, wherein the at least one return date is identified as every date within said date range which can accommodate a trip of the specified trip length within said date range.

21. A method of displaying fares for a plurality of travel itineraries having alternative travel dates, the method comprising the steps of:
creating a matrix of rows and columns;
defining date pairs at the intersections of the rows and columns;
listing fares at the intersections of the rows and columns, the fares corresponding to itineraries that include departure and return dates corresponding to the date pair defined by the row and column in which the fare is listed.

22. The method of claim 21 wherein said matrix is adapted to display itineraries for weekend trips within a specified time period.

23. The method of claim 22 wherein departure dates are listed along a first axis of said matrix, return days are listed along a second axis, and return dates are listed within said columns and grouped by weekend such that each departure date listed along the first axis is paired with a return date corresponding to each day listed along the second axis said departure date and return date pairs spanning a single weekend.

24. The method according to claim 21 wherein the matrix is adapted to display itineraries based around specified departure and return dates and a specified number of days around said specified departure and return dates.

25. The method of claim 24 wherein departure dates are listed along a first axis of the matrix, and return dates are listed along a second axis of the matrix.

26. The method of claim 21 wherein the matrix is adapted to display itineraries of a specified length within a specified date range.

27. The method of claim 26 wherein a plurality of departure dates are listed along a first axis and a plurality of different trip lengths are displayed along a second axis, return dates are listed at the intersections of the matrix rows and columns such that each return date corresponds to a trip of length equal to the trip length and a departure date equal to the departure date defined by the position of the return date with the matrix.

28. The method of claim 21 further comprising the step of highlighting a fare and each date of a date pair associated with said fare when a user points to said fare.

29. A system for searching for and displaying travel itineraries and fares for flexible travel schedules, comprising:
means for receiving a set of flexible travel requirements;
means for determining all pairs of departure and return dates that satisfy the flexible travel requirements;
search means for identifying itineraries corresponding to said date pairs.
